(19) United States
(12) Patent Application Publication
(10) Pub. No.: US 2025/0115161 A1
(43) Pub. Date: Apr. 10, 2025

(54) Apparatus For Controlling Battery Of Air Mobility And Method Thereof

(71) Applicants: Hyundai Motor Company, Seoul (KR); Kia Corporation, Seoul (KR)

(72) Inventors: Yoon Cheol Jeon, Suwon-Si (KR); Jong Pil Kim, Suwon-Si (KR); Woo Suk Jung, Gwangmyeong-Si (KR)

(21) Appl. No.: 18/654,343

(22) Filed: May 3, 2024

(30) Foreign Application Priority Data
Oct. 6, 2023 (KR) 10-2023-0133516

(51) Int. Cl. B60L 58/18

(52) U.S. Cl. CPC B60L 58/18; B60L 2200/10; B60L 2260/26; B60L 2270/20

(57) ABSTRACT

Disclosed are an apparatus for controlling a battery of air mobility and a method thereof. The apparatus maximizes the efficiency of a plurality of batteries provided in the air mobility by classifying the plurality of battery modules into a first battery group with high power characteristics and a second battery group with high energy characteristics, using power from the first battery group as a power source during takeoff and landing of the air mobility, and using power from the second battery group as the power source during cruising of the air mobility.

### CROSS-REFERENCE TO RELATED APPLICATION

This application claims the benefit of priority to Korean Patent Application No. 10-2023-0133516, filed in the Korean Intellectual Property Office on Oct. 6, 2023, the entire contents of which are incorporated herein by reference.

### TECHNICAL FIELD

The present disclosure relates to a technology for controlling a plurality of batteries that supply power to vehicles, including air mobility devices (e.g., for a vertical takeoff and landing aircraft).

### BACKGROUND

Advanced air mobility (AAM) is directed to a concept that encompasses urban air mobility (UAM), regional air mobility (RAM), and unmanned aircraft system (UAS). In this case, UAM may refer to an electric vertical takeoff and landing (eVTOL) aircraft for short-distance movement within a city. RAM and UAS may refer to an aircraft for long-distance movement between regions and an aircraft for logistics transport, respectively, and mainly use an electric conventional takeoff and landing (eCTOL) or electric short takeoff and landing (eSTOL) scheme.

Because the AAM may use a plurality of batteries (e.g., lithium-ion batteries) as a power source, the safety of the batteries is of utmost importance. In particular, when the battery power is not supplied during flight, it may cause a fatal accident (e.g., a crash), so not only must a redundancy battery be provided, but it must also be easy to switch between activating and deactivating of the redundancy battery.

In at least some implementations, when connecting a plurality of batteries provided in the AAM in parallel, all batteries must have the same voltage and capacity, and a DC-DC converter must be provided for each battery to constantly adjust the voltage between batteries.

To the contrary, when a plurality of batteries is connected in series to each other, there is no need to provide a DC-DC converter because the voltage of each battery does not need to be the same as the system voltage, and the weight of surplus batteries may be minimized. In particular, in a parallel battery structure, the lower limit voltage of the battery drops depending on battery usage, whereas in a series battery structure, when the system voltage drops depending on battery usage, the lower limit voltage of the system is maintained above a specified level by connecting a surplus battery.

This is directly related to the motor design voltage of AAM. When the system voltage is high in the process of outputting a specified output, the energizing current may be lowered, which may reduce or minimize heat generation at a motor side. Ultimately, the series battery structure may be suitable for aviation use because it can minimize the weight of the equipment that cools the motor. However, in order to connect batteries in series, it may be necessary to consider a structure for connecting a plurality of switches to a battery terminal block and a scheme of controlling the plurality of switches.

In addition, because AAM consumes more energy to rise to a cruising altitude (e.g., 500 to 600 m) than when cruising, consideration is required on what characteristics batteries should be provided and how to operate the batteries.

The matters described in this background section are intended to assist an understanding of the background of the disclosure and may include matters that are not already known to those of ordinary skill in the art.

### SUMMARY

The following summary presents a simplified summary of certain features. The summary is not an extensive overview and is not intended to identify key or critical elements.

An aspect of the present disclosure provides an apparatus for controlling a battery of air mobility and a method thereof that can maximize the efficiency of a plurality of batteries provided in the air mobility by classifying the plurality of battery modules, which supply power to the air mobility, into a first battery group including a high power density battery (HPDB) and a second battery group including a high energy density battery (HEDB), using power from the first battery group as a power source during takeoff and landing of the air mobility, and using power from the second battery group as the power source during cruising of the air mobility.

Another aspect of the present disclosure provides an apparatus for controlling a battery of air mobility and a method thereof that can maximize the efficiency of a plurality of batteries provided in the air mobility by classifying the plurality of battery modules, which supply power to the air mobility, into a first battery group including a high power density battery (HPDB) and a second battery group including a high energy density battery (HEDB), utilizing power from the second battery group when power from the first battery group is insufficient during takeoff and landing of the air mobility, and utilizing the power from the first battery group when the power from the second battery group is insufficient during cruising of the air mobility.

Still another aspect of the present disclosure provides an apparatus for controlling a battery of air mobility and a method thereof capable of ensuring flight safety of the air mobility by classifying the plurality of battery modules, which supply power to the air mobility, into a first battery group including a high power density battery (HPDB) and a second battery group including a high energy density battery (HEDB), and deactivating a first battery in the first battery group (or second battery group) and activating a surplus battery in the first battery group when a trouble occurs in the first battery, thereby ensuring that the power supplied to the air mobility is not interrupted.

Still another aspect of the present disclosure provides an apparatus for controlling a battery of air mobility and a method thereof capable of preventing a disconnection or short circuit by classifying the plurality of battery modules, which supply power to the air mobility, into a first battery group including a high power density battery (HPDB) and a second battery group including a high energy density battery (HEDB), and using an intermediate circuit while deactivating a first battery in the first battery group (or second battery group) when a trouble occurs in the first battery.

Still another aspect of the present disclosure provides an apparatus for controlling a battery of air mobility and a method thereof capable of preventing a disconnection or short circuit by classifying the plurality of battery modules, which supply power to the air mobility, into a first battery group including a high power density battery (HPDB) and a second battery group including a high energy density battery (HEDB), and using an intermediate circuit while activating a surplus battery in the first battery group when a trouble occurs in the first battery in the first battery group (or second battery group).

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

An apparatus for controlling a battery of an air mobility device may comprise: a plurality of battery modules configured to supply power to the air mobility device, wherein the plurality of battery modules comprises: a first battery group comprising at least one high power density battery (HPDB); and a second battery group comprising at least one high energy density battery (HEDB); and a controller configured to supply power from the first battery group to the air mobility device during takeoff and landing of the air mobility device, and supply power from the second battery group to the air mobility device during a cruising operation of the air mobility device.

Based on a malfunction associated with a first battery module in the first battery group, the controller may be configured to deactivate the first battery module and activate a surplus battery module in the first battery group.

The controller may be configured to activate the surplus battery module in the first battery group before deactivating the first battery module.

The first battery module may comprise: a battery; a bypass circuit having a bypass switch; an intermediate circuit having an intermediate switch; and a main switch configured to supply or cut off power of the battery.

The controller may be configured to turn on the intermediate switch for a preset time period, turn off the main switch during a turn-on state of the intermediate switch, and turn on the bypass switch during the turn-on state of the intermediate switch.

The intermediate circuit may be configured to prevent a disconnection that can occur when the main switch and the bypass switch are simultaneously turned off, and prevent a short circuit that can occur when the main switch and the bypass switch are simultaneously turned on.

The bypass circuit may further comprise: an inductor configured to control an intensity of an inrush current, and wherein the first battery module comprises a pyro-switch configured to completely cut off power to the battery.

Based on power from the first battery group being insufficient during takeoff and landing of the air mobility device, the controller may be configured to utilize additional power from the second battery group.

Based on power from the second battery group being insufficient during cruising of the air mobility device, the controller may be configured to utilize additional power from the first battery group.

The controller may be configured to control a plurality of first power supply switches and a plurality of first bypass switches to supply or cut off power from the first battery group, and control a plurality of second power supply switches and a plurality of second bypass switches to supply or cut off power from the second battery group.

A method of controlling a battery of air mobility device may comprise: controlling, by a controller, switching associated with a plurality of battery modules configured to supply power to the air mobility device, wherein the plurality of battery modules comprises: a first battery group comprising at least one high power density battery (HPDB); and a second battery group comprising at least one high energy density battery (HEDB); supplying, by the controller, power from the first battery group to the air mobility device during takeoff and landing of the air mobility device; and supplying, by the controller, power from the second battery group to the air mobility device during a cruising operation of the air mobility device.

An apparatus may comprise: a plurality of battery modules comprising: a first battery group configured to supply power to a plurality of motors for takeoff and landing of an air mobility device; and a second battery group configured to supply power to the plurality of motors for a cruising operation of the air mobility device; and a controller configured to control a plurality of first power supply switches and a plurality of first bypass switches to supply or cut off power from the first battery group, and control a plurality of second power supply switches and a plurality of second bypass switches to supply or cut off power from the second battery group.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is an example diagram of an apparatus for controlling a battery of air mobility;

FIG. 2 is a diagram illustrating an example of a powertrain of air mobility;

FIG. 3 is a diagram illustrating an example of a result of classifying a plurality of batteries according to characteristics by a controller provided in an apparatus for controlling a battery of air mobility;

FIG. 4 is a diagram illustrating an example of a result of classifying batteries according to characteristics of power and energy required during flight of air mobility by a controller provided in an apparatus for controlling a battery of air mobility;

FIG. 5 is a diagram illustrating an example of the power required during flight of air mobility;

FIG. 6 is a diagram illustrating a process of controlling power of a battery during takeoff of air mobility by a controller provided in an apparatus for controlling a battery of air mobility;

FIG. 7 is a diagram illustrating an example of a process of controlling power of a battery during cruising of air mobility by a controller provided in an apparatus for controlling a battery of air mobility;

FIG. 8 is a diagram illustrating an example of a process of controlling power of a battery during landing of air mobility by a controller provided in an apparatus for controlling a battery of air mobility;

FIG. 9 is a diagram illustrating an example of a process in which a controller provided in an apparatus for controlling a battery of air mobility according to an embodiment of the present disclosure maintains power of the air mobility when an abnormality occurs in a battery module;

FIG. 10A is a diagram illustrating an operation sequence of each switch in the first battery module shown in FIG. 9;

FIG. 10B is a diagram illustrating an operation sequence of each switch in the second battery module shown in FIG. 9;

FIG. 10C is a diagram illustrating an example of an operation sequence of each switch in the third battery module shown in FIG. 9;

FIG. 11 is a diagram illustrating a current, a voltage, and an output in a loading device shown in FIG. 9;

FIG. 12 is a flowchart illustrating a method of controlling a battery of air mobility; and

FIG. 13 is a block diagram illustrating a computing system for executing a method of controlling a battery of air mobility.

### DETAILED DESCRIPTION

Hereinafter, various examples of the present disclosure will be described in detail with reference to the exemplary drawings. In adding the reference numerals to the components of each drawing, it should be noted that the identical or equivalent component is designated by the identical numeral even when they are displayed on other drawings. Further, in describing various features of the present disclosure, a detailed description of the related known configuration or function will be omitted when it is determined that it interferes with the understanding of the gist of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

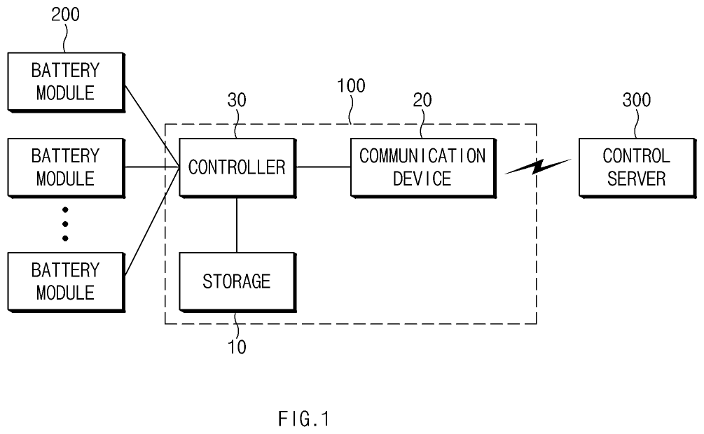

FIG. 1 is an example diagram of an apparatus for controlling a battery of air mobility.

As shown in FIG. 1, an apparatus 100 for controlling a battery of air mobility may include storage 10, a communication device 20, and a controller 30. In this case, depending on an apparatus 100 for controlling a battery of air mobility, components may be combined with each other to be implemented as one, or some components may be omitted.

Regarding each component, the storage 10 may store various logic, algorithms and programs required in the processes of classifying a plurality of batteries BAT #1, #2, . . . , and #N that supply power to air mobility into a first battery group including at least one high power density battery (HPDB) and a second battery group including at least one high energy density battery (HEDB), using power from the first battery group as a power source during takeoff and landing of the air mobility, and using power from the second battery group as a power source during cruising of the air mobility. For example, when a ratio between power density and energy density is less than 2 to 5, it is defined as the high energy density battery (HEDB), and when it is greater, it is defined as the high power density battery (HPDB).

The storage 10 may store various logic, algorithms and programs for performing the processes of classifying a plurality of batteries BAT #1, #2, . . . , and #N that supply power to air mobility into a first battery group including at least one HPDB and a second battery group including at least one HEDB, utilizing power from the second battery group (e.g., when power from the first battery group is insufficient during takeoff and landing of the air mobility, and utilizing the power from the first battery group when the power from the second battery group is insufficient during cruising of the air mobility).

The storage 10 may store various logic, algorithms and programs for performing the processes of classifying a plurality of batteries BAT #1, #2, . . . , and #N that supply power to air mobility into a first battery group including at least one HPDB and a second battery group including at least one HEDB, and when a trouble (e.g., a malfunction, an error, etc.) occurs in a first battery in the first battery group (or the second battery group), deactivating the first battery and activating a surplus battery in the first battery group.

The storage 10 may store various logic, algorithms and programs for performing the processes of classifying a plurality of batteries BAT #1, #2, . . . , and #N that supply power to air mobility into a first battery group including at least one HPDB and a second battery group including at least one HEDB, and when a trouble occurs in a first battery in the first battery group (or second battery group), deactivating the first battery by using an intermediate circuit.

The storage 10 may store various logic, algorithms and programs for performing the processes of classifying a plurality of batteries BAT #1, #2, . . . , and #N that supply power to air mobility into a first battery group including at least one HPDB and a second battery group including at least one HEDB, and when a trouble occurs in a first battery in the first battery group (or second battery group), activating a surplus battery in the first battery group by using an intermediate circuit.

The communication device 20, which is a module for providing a communication interface with a control server 300, may include at least one of a mobile communication module, a wireless Internet module, and a short-range communication module.

The mobile communication module may communicate with the control server 300 through a mobile communication network constructed according to a technical standard or communication scheme for mobile communication (e.g., global system for mobile communication (GSM), code division multiple access (CDMA), code division multiple access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), 5G New Radio, and the like).

The wireless Internet module, which is a module for wireless Internet access, may communicate with the control server 300 through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), 5G New Radio, and the like.

The short-range communication module may support short-range communication with the control server 300 by using at least one of Bluetooth™, radio frequency identification (RFID), infrared data association (IrDA), ultra wideband (UWB), ZigBee, near field communication (NFC), and wireless universal serial bus (USB) technology.

The controller 30 may perform overall control such that each component performs its function. The controller 30 may be implemented in the form of hardware or software, or may be implemented in a combination of hardware and software. In an example, the controller 30 may be implemented as a microprocessor, but aspects are not limited thereto.

Specifically, the controller 30 may classify a plurality of batteries BAT #1, #2, . . . , and #N that power air mobility into a first battery group including at least one HPDB and a second battery group including at least one HEDB, use power from the first battery group as a power source during takeoff and landing of the air mobility, and use power from the second battery group as a power source during cruising of the air mobility.

The controller 30 may utilize the power from the second battery group when power from the first battery group is insufficient during takeoff and landing of the air mobility.

The controller 30 may utilize the power from the first battery group when the power from the second battery group is insufficient during cruising of the air mobility.

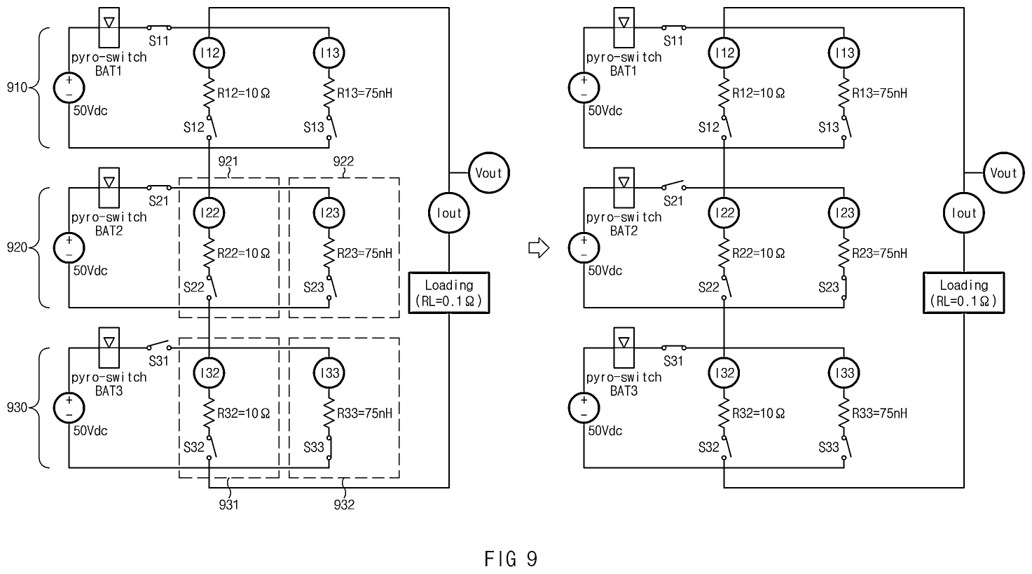

In an operation of deactivating a first battery and activating a surplus battery in the first battery group when a trouble occurs in the first battery in the first battery group (or the second battery group), the controller 30 may utilize an intermediate circuit as shown in FIG. 9 to prevent power supplied to the air mobility from being interrupted.

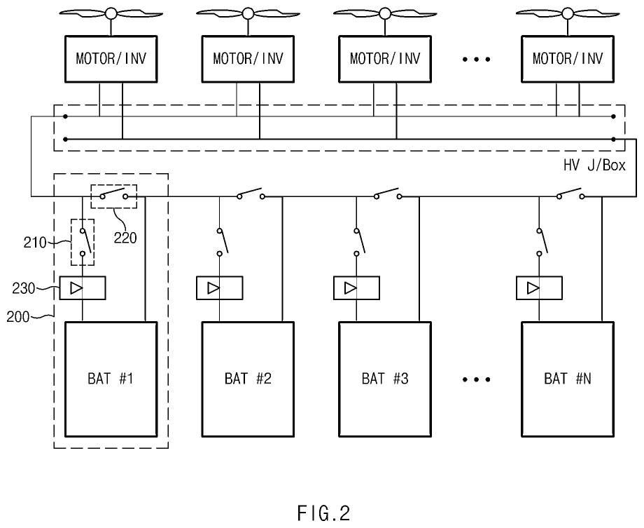

Hereinafter, the operation of the controller 30 will be described in detail with reference to FIGS. 2 to 11.

FIG. 2 is a diagram illustrating an example of a powertrain of air mobility.

As shown in FIG. 2, air mobility applied to an example of the present disclosure may include a plurality of rotors, a motor and an inverter connected to each rotor, and a plurality of batteries that supply power to each motor. In this case, a plurality of batteries BAT #1, #2, . . . , and #N may be connected to each other in series.

In this case, a battery module 200 may include a main switch 210 (e.g., a power supply switch) that supplies or blocks power from the battery BAT #1 to a motor, a bypass switch 220 that allows the battery BAT #1 to bypass the entire circuit, and a pyro-switch 230 that completely disconnects the battery BAT #1 from the entire circuit. This configuration applies equally to all battery modules in air mobility.

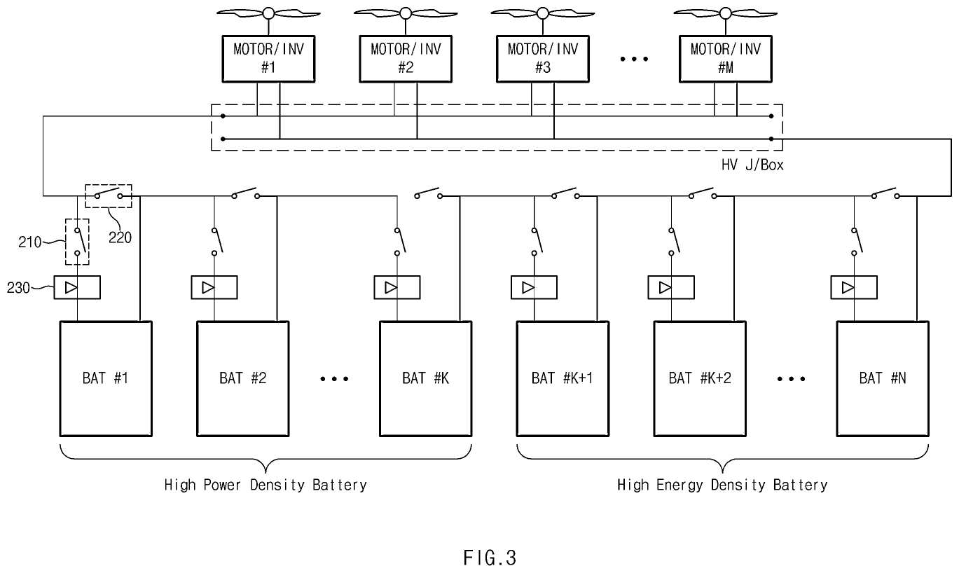

FIG. 3 is a diagram illustrating an example of a result of classifying a plurality of batteries according to characteristics by a controller provided in an apparatus for controlling a battery of air mobility.

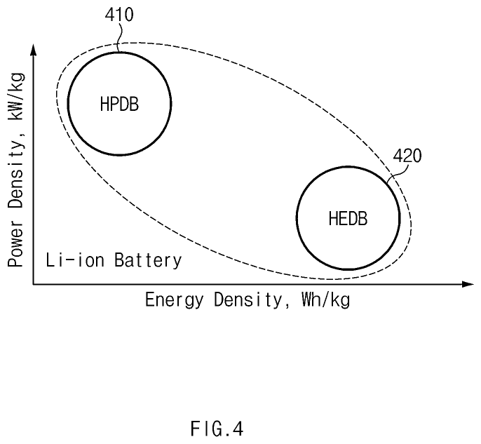

As shown in FIG. 3, the controller 30 may classify the plurality of batteries BAT #1, #2, . . . , and #N provided in the air mobility into a first battery group BAT #1, #2, . . . , and #K including at least one HPDB and a second battery group BAT #K+1, #K+2, . . . , and #N including at least one HEDB. In this case, the controller 30 may classify each battery as HPDB or HEDB based on attribute information of each battery provided in the air mobility. In this case, the first battery group and the second battery group may have characteristics as shown in FIG. 4.

FIG. 4 is a diagram illustrating an example of a result of classifying batteries according to characteristics of power and energy required during flight of air mobility by a controller provided in an apparatus for controlling a battery of air mobility.

In FIG. 4, the horizontal axis represents energy density, the vertical axis represents power density, reference numeral 410 represents a high power density battery (HPDB), and reference numeral 420 represents a high energy density battery (HEDB). For reference, power is an indicator of how quickly work can be done, and energy is an indicator of how much work can be done. The relationship between power P and energy E is established expressed as following Equation 1. That is, because both power and energy cannot be high, the time T required for discharging is shortened when power P is high, and the time T required for discharging becomes longer when energy E is high.

$$E = P \times T \qquad [ Equation 1 ]$$

Where ‘E’ represents energy, ‘P’ represents power, and ‘T’ represents time.

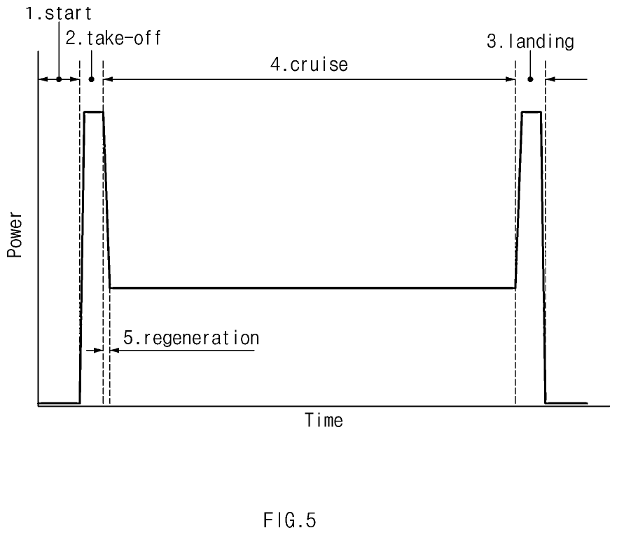

The power required in the sequential operations of starting, takeoff, cruising, and landing of air mobility is as shown in FIG. 5.

FIG. 5 is a diagram illustrating an example of the power required during flight of air mobility.

As shown in FIG. 5, air mobility (e.g., an air mobility vehicle) may require high power during takeoff after start, relatively low power during cruising, and high power during landing.

Accordingly, the controller 30 may use power from the first battery group including at least one HPDB 410 as a power source during takeoff and landing of air mobility, and use power from the second battery group including at least one HEDB 420 as a power source during cruising of air mobility.

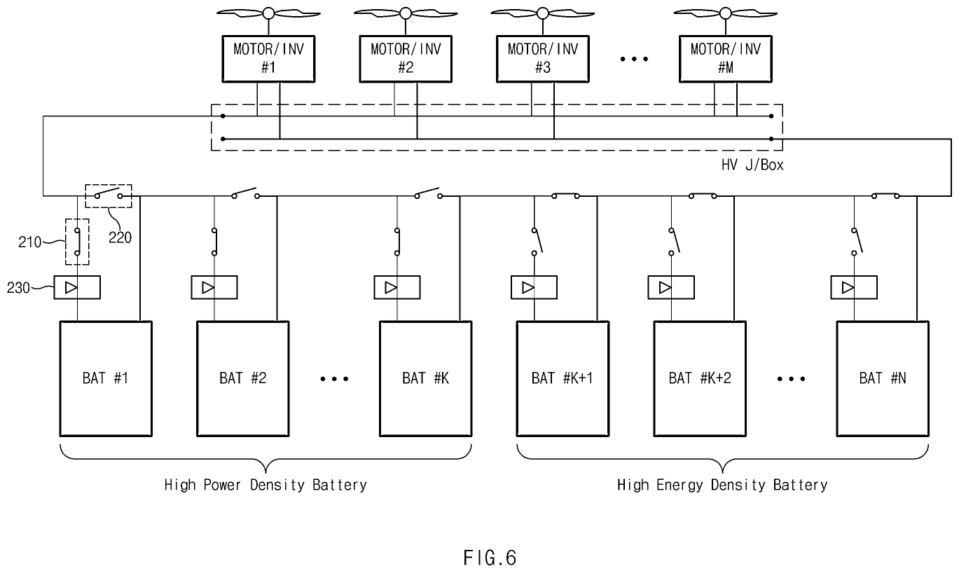

FIG. 6 is a diagram illustrating a process of controlling power of a battery during takeoff of air mobility by a controller provided in an apparatus for controlling a battery of air mobility.

As shown in FIG. 6, the controller 30 turns on the main switch 210 in each battery module included in the first battery group and turns off the bypass switch 220 when the air mobility takes off. At the same time, the controller 30 allows the main switch 210 in each battery module included in the second battery group to be maintained in a turn-off state and allows the bypass switch 220 to be maintained in a turn-on state.

Accordingly, the air mobility may takeoff by using the power from the first battery group including the plurality of HPDBs 410. After takeoff, the remaining state of charge (SOC) of the first battery group is sufficiently higher than the SOC required by the air mobility during the landing process.

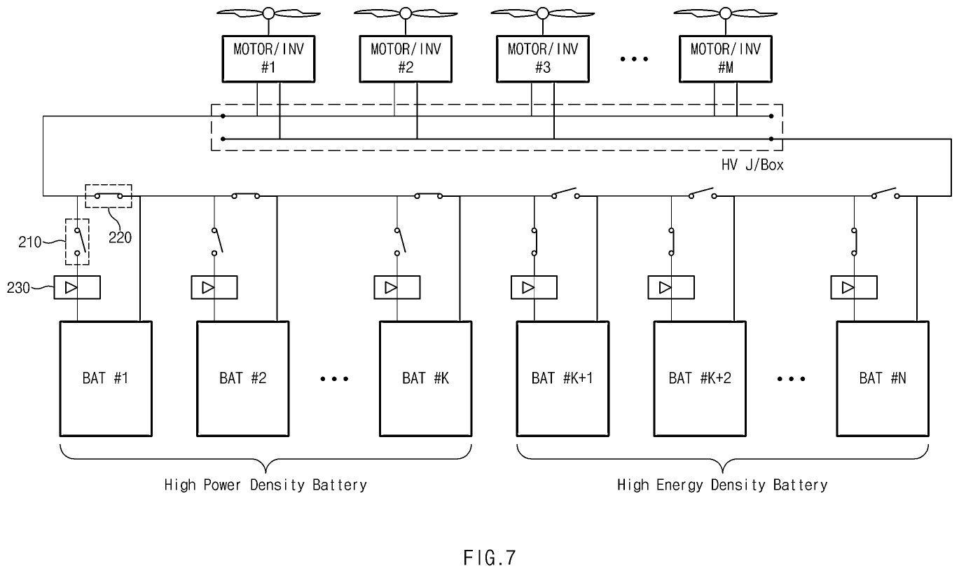

FIG. 7 is a diagram illustrating an example of a process of controlling power of a battery during cruising of air mobility by a controller provided in an apparatus for controlling a battery of air mobility.

As shown in FIG. 7, the controller 30 turns off the main switch 210 in each battery module included in the first battery group and turns on the bypass switch 220 during cruising of the air mobility. In addition, the controller 30 turns on the main switch 210 and turns off the bypass switch 220 in each battery module included in the second battery group. In this case, the controller 30 may control the power supplied to the air mobility to continue without interruption.

Accordingly, the air mobility may cruise using power from the second battery group including the plurality of HEDBs 420.

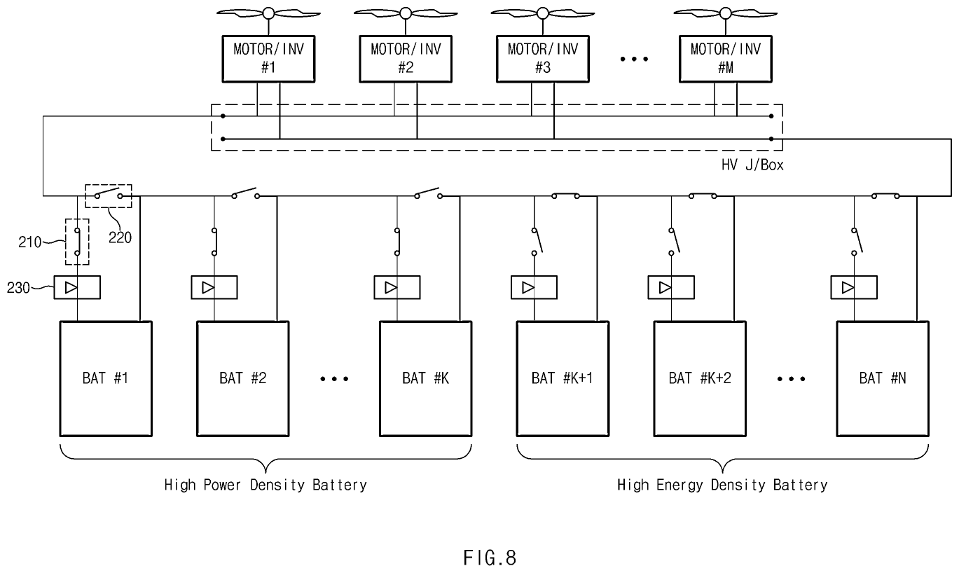

FIG. 8 is a diagram illustrating an example of a process of controlling power of a battery during landing of air mobility by a controller provided in an apparatus for controlling a battery of air mobility.

As shown in FIG. 8, the controller 30 turns on the main switch 210 in each battery module included in the first battery group and turns off the bypass switch 220 during landing of the air mobility. In addition, the controller 30 turns off the main switch 210 and turns on the bypass switch 220 in each battery module included in the second battery group. In this case, the controller 30 may control the power supplied to the air mobility to continue without interruption.

Accordingly, the air mobility may land using power from the first battery group including the plurality of HPDBs 410.

FIG. 9 is a diagram illustrating an example of a process in which a controller provided in an apparatus for controlling a battery of air mobility maintains power of the air mobility when an abnormality occurs in a battery module.

In FIG. 9, reference numeral 910 represents a first battery module, reference numeral 920 represents a second battery module, and reference numeral 930 represents a third battery module. In addition, reference numeral 921 represents an intermediate circuit within the second battery module 920, and reference numeral 922 represents a bypass circuit within the second battery module 920. In addition, reference numeral 931 represents an intermediate circuit within the third battery module 930, and reference numeral 932 represents a bypass circuit within the third battery module 930. In this case, as an example switching sequence, a PWM frequency may be 1 kHz and the duty may be 50%. But in at least some other implementations, different MWP frequency and different duty ratio may be used.

For example, the first battery module 910 and the second battery module 920 may be in a state in which power is supplied to air mobility, and the third battery module 930 may be a surplus battery module. In this case, when a trouble occurs in the second battery module 920, the controller 30 may deactivate the second battery module 920 and activate the third battery module 930.

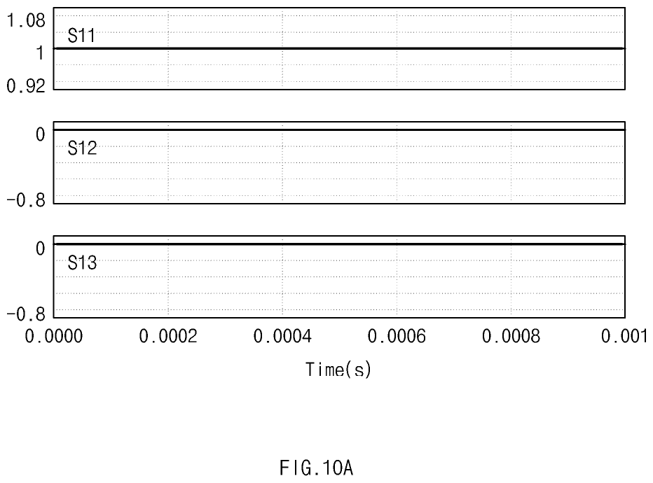

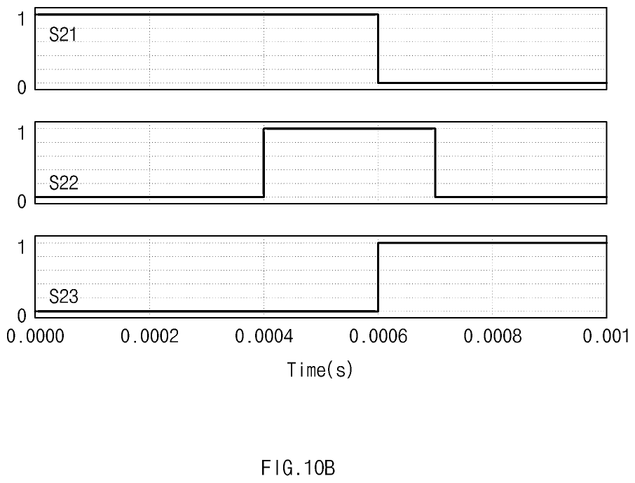

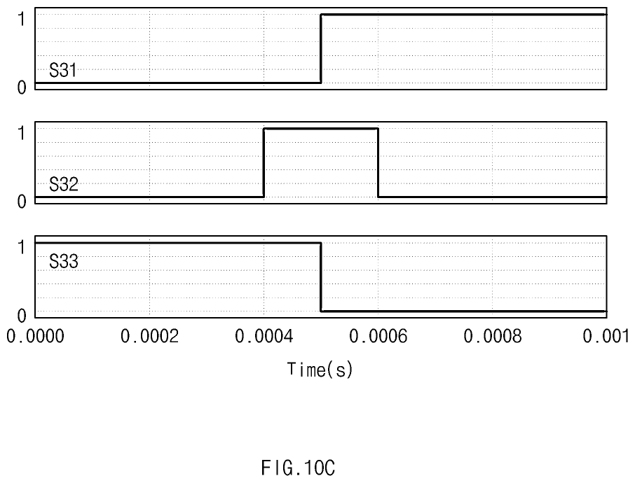

In an example, in the process of deactivating the second battery module 920, the controller 30 turns on an intermediate switch S22 in the intermediate circuit 921, turns off a main switch S21 in the second battery module 920, turns on a bypass switch S23 in the bypass circuit 922, and turns off the intermediate switch S22 in the intermediate circuit (e.g., in a sequential switching process as shown in FIG. 10B). In this case, the reason for turning on the intermediate switch S22 in the intermediate circuit 921 for a specified time period is to prevent a system disconnection that occurs when the main switch S21 and the bypass switch S23 are turned off at the same time, and a short circuit that occurs when the main switch S21 and the bypass switch S23 are turned on at the same time. In particular, an inductor L23 may perform a function of controlling the intensity of an inrush current I23.

In the process of activating the third battery module 930, the controller 30 turns on an intermediate switch S32 in the intermediate circuit 931, turns on a main switch S31 in the third battery module 930, turns off a bypass switch S33 in the bypass circuit 932, and turns off the intermediate switch S32 in the intermediate circuit 931 (e.g., in a sequential switching process as shown in FIG. 10C). In this case, the reason for turning on the intermediate switch S32 in the intermediate circuit 931 for a specified time period is to prevent a system disconnection that occurs when the main switch S31 and the bypass switch S33 are turned off at the same time, and a short circuit that occurs when the main switch S31 and the bypass switch S33 are turned on at the same time. In particular, an inductor L33 may perform a function of controlling the intensity of an inrush current I33.

FIG. 10A is a diagram illustrating an operation sequence of each switch in the first battery module shown in FIG. 9.

As shown in FIG. 9, the first battery module 910 continues to operate normally. In this process, as shown in FIG. 10A, it may be confirmed that the main switch S11 in the first battery module 910 is maintained in a turn-on state, the intermediate switch S12 is maintained in a turn-off state, and the bypass switch S13 is maintained a turn-off state.

FIG. 10B is a diagram illustrating an operation sequence of each switch in the second battery module shown in FIG. 9.

As shown in FIG. 9, a trouble occurs in the second battery module 920 and the second battery module 920 is deactivated.

In this process, as shown in FIG. 10B, the intermediate switch S22 in the second battery module 920 is switched from the turn-off state to the turn-on state for a specified time period (e.g., 0.0004 to 0.0007 seconds) and then is maintained in the turn-off state again. The main switch S21 is maintained in the turn-on state and then switches to the turn-off state (e.g., after 0.0006 seconds). In this case, the bypass switch S23 is maintained in the turn-off state and switches to the turn-on state (e.g., after 0.0006 seconds).

Accordingly, it may be confirmed that the main switch S21 is turned off and the bypass switch S23 is turned on while the intermediate switch S22 is maintained in the turn-on state. For reference, although it is an ideal situation that the turn-off time point of the main switch S21 and the turn-on time point of the bypass switch S23 are the same, this is not very likely in at least some implementations. The intermediate circuit 921 performs a complementary function.

FIG. 10C is a diagram illustrating an example of an operation sequence of each switch in the third battery module shown in FIG. 9.

As shown in FIG. 9, the third battery module 930 is activated.

In this process, as shown in FIG. 10C, the intermediate switch S32 in the third battery module 930 is switched from the turn-off state to the turn-on state for a specified time period (e.g., 0.0004 to 0.0006 seconds) and then is maintained in the turn-off state again. The main switch S31 is maintained in the turn-off state and then switches to the turn-on state (e.g., after 0.0005 seconds). In this case, the bypass switch S33 is maintained in the turn-on state and switches to the turn-off state (e.g., after 0.0005 seconds).

Accordingly, it may be confirmed that the main switch S31 is turned on and the bypass switch S33 is turned off while the intermediate switch S32 is maintained in the turn-on state. For reference, although it is an ideal situation that the turn-on time point of the main switch S31 and the turn-off time point of the bypass switch S33 are the same, this is not very likely in at least some implementations. The intermediate circuit 931 performs a complementary function.

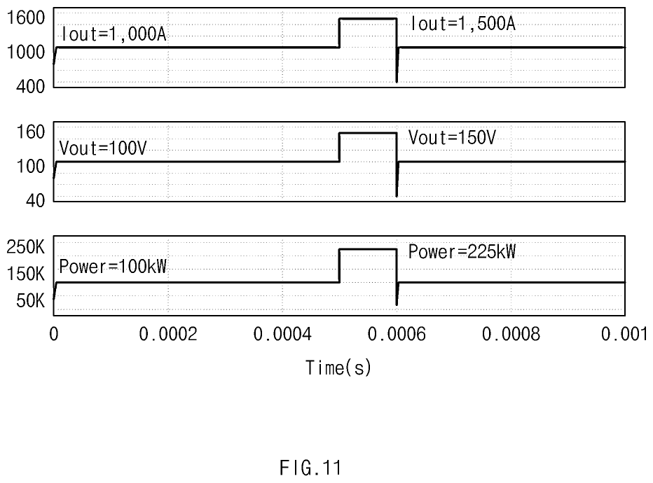

FIG. 11 is a diagram illustrating a current, a voltage, and an output in a loading device shown in FIG. 9.

As shown in FIG. 11, in the process of deactivating the second battery module 920 in which a trouble occurs and activating the third battery module 930 in a normal state, although a slightly high current (e.g., 1,500 A), voltage (e.g., 150 V) and output (e.g., 225 kw) occur, a normal current (e.g., 1,000 A), voltage (e.g., 100 V) and output (e.g., 100 kW) occur in all sections without interruption except for it.

Thus, it may be confirmed that sufficient power required for air mobility is provided in the process of replacing the second battery module 920 with the third battery module 930 by the controller 30.

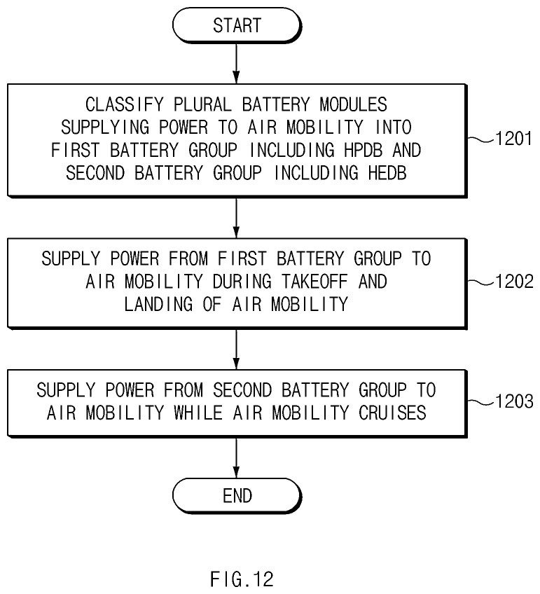

FIG. 12 is a flowchart illustrating a method of controlling a battery of air mobility.

In 1201, the controller 30 may classify the plurality of battery modules, which supply power to air mobility, into the first battery group including a high power density battery (HPDB) and the second battery group including a high energy density battery (HEDB).

In 1202, during takeoff and landing of the air mobility, the controller 30 may supply power from the first battery group to the air mobility.

In 1203, while the air mobility cruises, the controller 30 may supply power from the second battery group to the air mobility.

According to an aspect of the present disclosure, an apparatus for controlling a battery of air mobility includes a plurality of battery modules that supplies power to the air mobility, and a controller that classifies the plurality of battery modules into a first battery group including a high power density battery (HPDB) and a second battery group including a high energy density battery (HEDB), supplies power from the first battery group to the air mobility during takeoff and landing, and supplies power from the second battery group to the air mobility during cruising.

According to an example, the controller may deactivate a first battery module in the first battery group and activate a surplus battery module in the first battery group when a trouble occurs in the first battery module.

According to an example, the controller may first activate a surplus battery module in the first battery group and then deactivate the first battery module.

According to an example, the first battery module may include a battery, a bypass circuit having a bypass switch, an intermediate circuit having an intermediate switch, and a main switch that supplies or cuts off power of the battery.

According to an example, the controller may turn on the intermediate switch for a preset time period, turn off the main switch in a turn-on state of the intermediate switch, and turn on the bypass switch in the turn-on state of the intermediate switch.

According to an example, the intermediate circuit may prevent a disconnection that occurs when the main switch and the bypass switch are simultaneously turned off, and prevent a short circuit that occurs when the main switch and the bypass switch are simultaneously turned on.

According to an example, the bypass circuit may further include an inductor that controls an intensity of an inrush current.

According to an example, the first battery module may include a pyro-switch that completely cuts off power to the battery.

According to an example, the controller may utilize power from the second battery group when power from the first battery group is insufficient during takeoff and landing of the air mobility.

According to an example, the controller may utilize power from the first battery group when power from the second battery group is insufficient during cruising of the air mobility.

According to another aspect of the present disclosure, a method of controlling a battery of air mobility includes classifying, by a controller, a plurality of battery modules which supply power to the air mobility into a first battery group including a high power density battery (HPDB) and a second battery group including a high energy density battery (HEDB), supplying power from the first battery group to the air mobility during takeoff and landing of the air mobility, and supplying power from the second battery group to the air mobility during cruising of the air mobility.

According to an example, the method may further include activating, by the controller, a surplus battery module in the first battery group when a trouble occurs in a first battery module in the first battery group, and deactivating the first battery module.

According to an example, the deactivating of the first battery module may include deactivating, by the controller, the first battery module after activating the surplus battery module.

According to an example, the deactivating of the first battery module may include turning on, by the controller, the intermediate switch for a preset time period, turning off, by the controller, the main switch in a turn-on state of the intermediate switch, and turning on, by the controller, the bypass switch in the turn-on state of the intermediate switch.

According to an example, the deactivating of the first battery module may include controlling, by the controller, the intermediate circuit to prevent the main switch and the bypass switch from being turned off simultaneously, and controlling, by the controller, the intermediate circuit to prevent the main switch and the bypass switch from being turned on simultaneously.

According to an example, the supplying of the power from the first battery group to the air mobility may include utilizing, by the controller, power from the second battery group when the power from the first battery group is insufficient.

According to an example, the supplying of the power from the second battery group to the air mobility may include utilizing, by the controller, power from the first battery group when the power from the second battery group is insufficient.

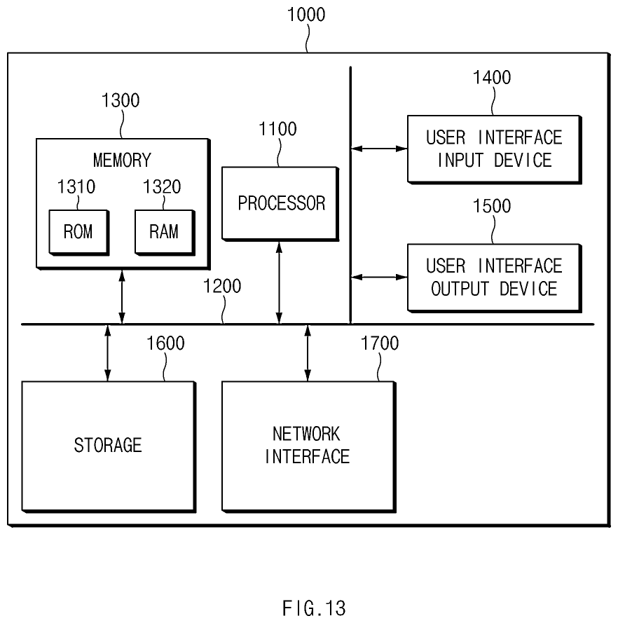

FIG. 13 is a block diagram illustrating a computing system for executing a method of controlling a battery of air mobility.

Referring to FIG. 13, a method of controlling a battery of air mobility according to the present disclosure described above may be implemented through a computing system 1000. The computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the features of the present disclosure described herein may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to one or more aspects of the present disclosure, it is possible to maximize the efficiency of a plurality of batteries provided in the air mobility by classifying the plurality of battery modules, which supply power to the air mobility, into a first battery group including a high power density battery (HPDB) and a second battery group including a high energy density battery (HEDB), using power from the first battery group as a power source during takeoff and landing of the air mobility, and using power from the second battery group as the power source during cruising of the air mobility.

Although exemplary embodiment(s) of the present disclosure have been described for illustrative purposes, those skilled in the art will appreciate that various modifications, additions and substitutions are possible, without departing from the scope and spirit of the disclosure. Therefore, the exemplary embodiment(s) disclosed in the present disclosure are provided for the sake of descriptions, not limiting the technical concepts of the present disclosure, and it should be understood that such exemplary embodiment(s) are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling a battery of an air mobility device, the apparatus comprising:
a plurality of battery modules configured to supply power to the air mobility device, wherein the plurality of battery modules comprises:
a first battery group comprising at least one high power density battery (HPDB); and
a second battery group comprising at least one high energy density battery (HEDB); and
a controller configured to supply power from the first battery group to the air mobility device during takeoff and landing of the air mobility device, and supply power from the second battery group to the air mobility device during a cruising operation of the air mobility device.

2. The apparatus f claim 1, wherein based on a malfunction associated with a first battery module in the first battery group, the controller is configured to deactivate the first battery module and activate a surplus battery module in the first battery group.

3. The apparatus of claim 2, wherein the controller is configured to activate the surplus battery module in the first battery group before deactivating the first battery module.

4. The apparatus of claim 2, wherein the first battery module comprises:
a battery;
a bypass circuit having a bypass switch;
an intermediate circuit having an intermediate switch; and
a main switch configured to supply or cut off power of the battery.

5. The apparatus of claim 4, wherein the controller is configured to turn on the intermediate switch for a preset time period, turn off the main switch during a turn-on state of the intermediate switch, and turn on the bypass switch during the turn-on state of the intermediate switch.

6. The apparatus of claim 4, wherein the intermediate circuit is configured to prevent a disconnection that can occur when the main switch and the bypass switch are simultaneously turned off, and prevent a short circuit that can occur when the main switch and the bypass switch are simultaneously turned on.

7. The apparatus of claim 4, wherein the bypass circuit further comprises:
an inductor configured to control an intensity of an inrush current, and
wherein the first battery module comprises a pyro-switch configured to completely cut off power to the battery.

8. The apparatus of claim 1, wherein based on power from the first battery group being insufficient during takeoff and landing of the air mobility device, the controller is configured to utilize additional power from the second battery group.

9. The apparatus of claim 1, wherein based on power from the second battery group being insufficient during cruising of the air mobility device, the controller is configured to utilize additional power from the first battery group.

10. The apparatus of claim 1, wherein the controller is configured to control a plurality of first power supply switches and a plurality of first bypass switches to supply or cut off power from the first battery group, and control a plurality of second power supply switches and a plurality of second bypass switches to supply or cut off power from the second battery group.

11. A method of controlling a battery of air mobility device, the method comprising:
controlling, by a controller, switching associated with a plurality of battery modules configured to supply power to the air mobility device, wherein the plurality of battery modules comprises:
a first battery group comprising at least one high power density battery (HPDB); and
a second battery group comprising at least one high energy density battery (HEDB);
supplying, by the controller, power from the first battery group to the air mobility device during takeoff and landing of the air mobility device; and
supplying, by the controller, power from the second battery group to the air mobility device during a cruising operation of the air mobility device.

12. The method of claim 11, further comprising:
based on a malfunction associated with a first battery module in the first battery group:
activating, by the controller, a surplus battery module in the first battery group; and
deactivating the first battery module.

13. The method of claim 12, wherein the deactivating of the first battery module comprises:
deactivating, by the controller, the first battery module after activating the surplus battery module.

14. The method of claim 12, wherein the first battery module comprises:
a battery;
a bypass circuit having a bypass switch;
an intermediate circuit having an intermediate switch; and
a main switch configured to supply or cut off power of the battery.

15. The method of claim 14, wherein the deactivating of the first battery module comprises:
turning on, by the controller, the intermediate switch for a preset time period;
turning off, by the controller, the main switch during a turn-on state of the intermediate switch; and
turning on, by the controller, the bypass switch during the turn-on state of the intermediate switch.

16. The method of claim 14, wherein the deactivating of the first battery module comprises:
controlling, by the controller, the intermediate circuit to prevent the main switch and the bypass switch from being turned off simultaneously; and
controlling, by the controller, the intermediate circuit to prevent the main switch and the bypass switch from being turned on simultaneously.

17. The method of claim 14, wherein the bypass circuit further comprises:
an inductor configured to control an intensity of an inrush current, and
wherein the first battery module comprises a pyro-switch configured to completely cut off power to the battery.

18. The method of claim 11, wherein the supplying of the power from the first battery group to the air mobility device comprises:
based on the power from the first battery group being insufficient, utilizing, by the controller, additional power from the second battery group.

19. The method of claim 11, wherein the supplying of the power from the second battery group to the air mobility device comprises:
based on the power from the second battery group being insufficient, utilizing, by the controller, additional power from the first battery group.

20. An apparatus comprising:
a plurality of battery modules comprising:
a first battery group configured to supply power to a plurality of motors for takeoff and landing of an air mobility device; and
a second battery group configured to supply power to the plurality of motors for a cruising operation of the air mobility device; and
a controller configured to control a plurality of first power supply switches and a plurality of first bypass switches to supply or cut off power from the first battery group, and control a plurality of second power supply switches and a plurality of second bypass switches to supply or cut off power from the second battery group.
